(19) United States
(12) Patent Application Publication
(10) Pub. No.: US 2005/0097769 A1
(43) Pub. Date: May 12, 2005

(54) Loadlock

(76) Inventors: Jing-Cheng Lin, Hsinchu (TW); Shing-Chyang Pan, Tainan (TW); Hsien-Ming Lee, Changhua (TW); Hung-Wen Su, Hsinchu (TW); Shih-Wei Chou, Taipei (TW); Ming-Hsing Tsai, Taipei (TW); Shau-Lin Shue, Hsinchu (TW)

Correspondence Address: BIRCH STEWART KOLASCH & BIRCH, PO BOX 747, FALLS CHURCH, VA, 22040-0747, US

(21) Appl. No.: 10/668,291

(22) Filed: Sep. 24, 2003

(51) Int. Cl. F26B 13/30

(52) U.S. Cl. 34/92

(57) ABSTRACT

A loadlock. The loadlock for wafers includes a chamber, a pedestal, a retractable shaft, and a bellows. The chamber has a plurality of walls and a bottom surface. The pedestal supports a cassette and is disposed in the chamber. The retractable shaft has a top end and a bottom end. The top end is connected to the pedestal and the bottom end is connected to the bottom surface as a reference for positioning the pedestal. The bellows has a first end and a second end. The first end is disposed on the pedestal and the second end is sealed at the bottom end of the retractable shaft. Preferably, the retractable shaft is fully enclosed by the bellows.

### BACKGROUND OF THE INVENTION

1. Field of the Invention

The present invention relates to a loadlock, and more particularly to a loadlock comprising a bellows or a metal attractor to prevent lubricant contamination and to efficiently minimize swirl defects.

2. Description of the Related Art

Many semiconductor fabrication processes occur in reduced pressure and/or gas flow environments. Substrate processing is usually carried out in vacuum reaction chambers, such as physical vapor deposition (PVD) chamber, chemical vapor deposition (CVD) chamber and low pressure dry etching chamber. The PVD process is usually carried out in a loadlock, mainly for loading and unloading a cassette of wafers, requiring vacuum conditions and removal of gaseous contaminants before wafers are processed. After wafers are loaded into the loadlock, they are delivered to the next reaction chamber for processes such as barrier layer deposition. Generally, impurities in the reaction chambers are H₂O, H₂, CO, CO₂, and CH₄. There are also other impurities in the loadlock such as C₆H₅—CH₂ and F₂. Those impurities are mainly removed by conventional chamber cleaning devices. Even though conventional chamber cleaning devices clean wafer surfaces and improve yield rate, as shown in FIG. 1, some processed wafers 110, after electrical plating, are contaminated due to swirl defects 10. Even after preventive maintenance, the problem still occurs and negatively impacts yield rate.

FIG. 2 shows the relationship between the time and the contamination levels (represented by a signal) on wafers based on a residual gas analysis (RGA) spectrum. After each wafer is successfully processed but before returned to a cassette in the PVD loadlock, RGA mass spectrum is performed to monitor contamination levels for the first few wafers. The contamination levels of those wafers are at an acceptable level, as marked by a symbol “CTL” in FIG. 2. However, after the wafers are delivered to a conventional loadlock, the contamination level of wafer (1) increases suddenly, as shown in FIG. 2. The contamination levels on subsequent wafers (2), (3), (4), (5), and (6) are getting lower and lower as shown in FIG. 2; however, those signal levels are still higher than the acceptable level “CTL”.

FIG. 3 is a perspective view of a conventional loadlock 100 comprising a shaft 108. The shaft 108 rotatably moves up and down to adjust the position of a pedestal to deliver wafers 110 in a cassette 104 into the next reaction chamber (not shown in FIG. 3). As mentioned above, after the wafers 110 are processed and returned to the loadlock 100, swirl defects occur and affect the first six processed wafers out of 25 wafers in the cassette. The contamination level on the first processed wafer is the highest and the level on the subsequent wafers decreases gradually. The contamination levels of the seventh through the last wafers return to negligible contamination levels. According to the RGA analysis, it shows that CF₃⁺ ions with 69 atomic mass units (amu) are the main contaminants on wafers 110.

To find out where the contaminants come from, we have to look at the operations of the conventional loadlock. The shaft 108 of the conventional loadlock 100 requires an essential lubricant to precisely adjust the positions of the wafers 110 and the pedestal 106, thereby facilitating transportation of wafers 110 from the reaction chamber into the cassette 104 in the loadlock 100, and vice versa. The chemical structure of the lubricant is F—(CF—CF₂—O)ₙ—CF₂CF₃, wherein n=10-60. The lubricant, under high temperature and low pressure conditions, tends to evaporate to a gaseous phase, so that the bond between CF₃⁺ ions and F—(CF—CF₂—O)ₙ—CF₂CF₃ is easily broken.

Another RGA spectrum is performed in the conventional loadlock to show outgas levels when the shaft 108 moves, as shown in FIG. 4. This analysis focuses on the RGA spectrum of any outgases from the loadlock. For simplicity, FIG. 4 only shows outgas levels of H₂O with 18 amu, CF₃⁺ with 69 amu, and Ar with 40 amu. As shown in FIG. 4, the signal level increases significantly due to the movement of the shaft 108 as indicated at time (b). For example, the signal level of outgas H₂O with 18 amu initially increases to a high level between lxe⁻⁸ and lxe⁻⁷ at time (b) when a silt valve (not shown) of the loadlock is open. Then the signal level decreases to a level between lxe⁻¹⁰ and lxe⁻⁹. However, due to the movement of the shaft 108 in the loadlock during the time period (c), the signal level suddenly increases again to a level near lxe⁻⁹. Likewise, the outgas CF₃⁺ with 69 amu shows a rough curve similar to the curve of H₂O, showing a sudden jump in signal level between lxe¹² and lxe⁻¹¹ during shaft movement. When the shaft 108 moves, CF₃⁺ ions generated from the lubricant diffuse throughout the inner space of the loadlock, which causes to the sudden increase in the signal level. Moreover, this lubricant has an affinity for metal, alloy steels, copper, stainless steels, and other metals such as aluminum alloy, titanium alloy, nickel alloy, and cobalt alloy. Therefore, CF₃+ tends to be directly absorbed into the surface of the wafer, usually a copper surface at a high temperature. Later, the silt valve is open at time (d), and again, the signal level increases suddenly due to shaft movement. Thus, it shows that the major source of contamination and swirl defects is the lubricant vapor in the loadlock.

Hence, a solution to the contamination and swirl defects on wafers in the PVD loadlock is needed to prevent the undesirable lubricant contamination and to minimizes swirl defects on the wafer surfaces.

### SUMMARY OF THE INVENTION

It is an object of the present invention to provide a loadlock that prevents undesirable lubricant contamination.

It is another object of the present invention to provide a loadlock that minimizes swirl defects on the wafer surfaces.

The present invention requires only a few components such as a bellows or a metal attractor, thereby cost-effectively preventing lubricant diffusion into the chamber and penetration into wafers.

The present invention provides a loadlock for delivering wafers in a cassette. The loadlock comprises a chamber, a pedestal, a retractable shaft, and a bellows. The chamber has a at least a wall and a bottom surface. The pedestal supports the cassette and is disposed in the chamber. The retractable shaft has a top end and a bottom end. The top end is connected to the pedestal and the bottom end is connected to the bottom surface. The bellows has a first end and a second end. The first end is disposed on the pedestal and the second end sealed at the bottom end of the retractable shaft. Preferably, the retractable shaft is fully enclosed by the bellows.

In a preferred embodiment of the present invention, the loadlock further comprises at least a metal attractor disposed on the wall of the chamber or on the pedestal. The metal attractor is at least one of copper, aluminum, titanium, nickel, cobalt, tantalum, iron or alloys thereof.

The present invention also provides a loadlock comprising a chamber, a pedestal, a retractable shaft, and a flexible sleeve. The pedestal is disposed in the chamber. The retractable shaft supports the pedestal. The flexible sleeve encloses the retractable shaft. Preferably, the flexible sleeve has a bellows structure and is compressible by external force.

The present invention further provides a loadlock comprising a chamber, a cassette, a pedestal, and a plurality of attractors. The chamber has a plurality of walls. The cassette containing a plurality of wafers is disposed in the chamber. The pedestal supports the cassette. The attractors are disposed on the pedestal and on the walls, respectively. The attractor is at least one of copper, aluminum, titanium, nickel, cobalt, tantalum, iron, or alloys thereof.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, which are given by way of illustration only, and thus are not limitative of the present invention, and wherein:

FIG. 1 is a perspective view of a contaminated wafer with swirl defects;

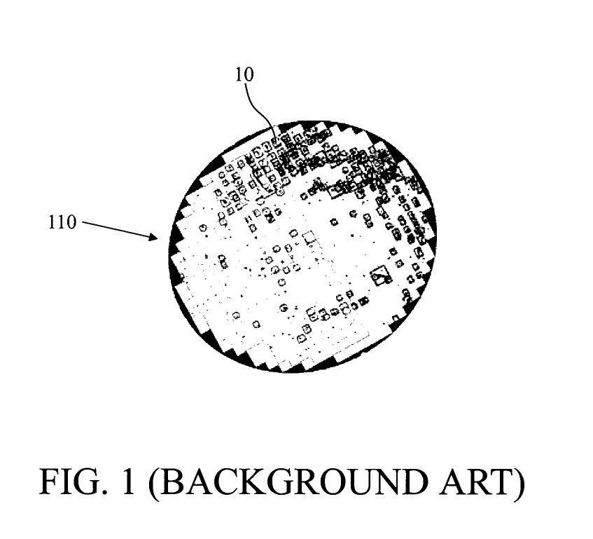

FIG. 2 shows the relationship between the time and the contamination levels (represented by a signal) on wafers based on a residual gas analysis (RGA) spectrum;

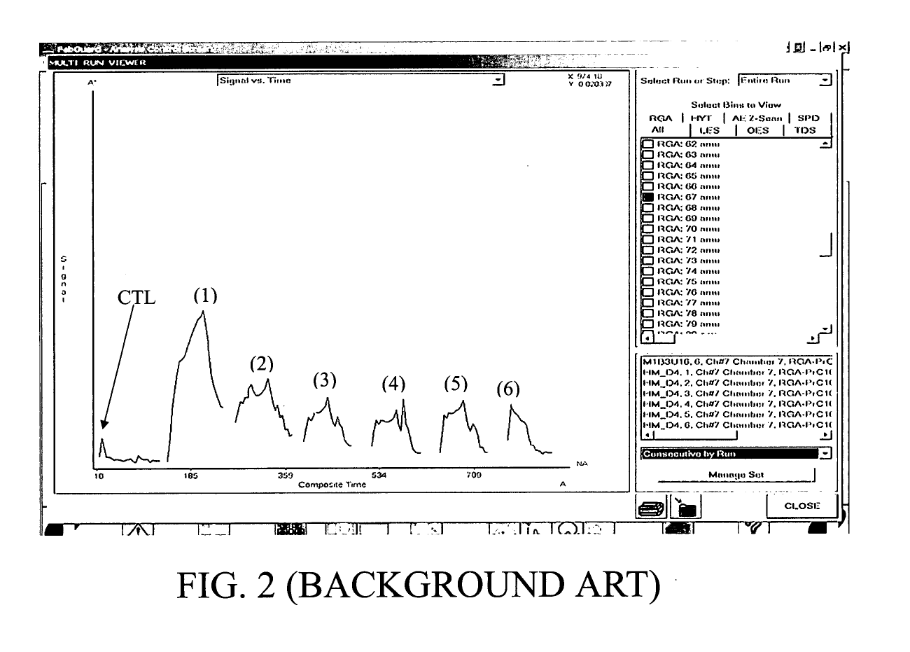

FIG. 3 is an exploded perspective view of a conventional loadlock;

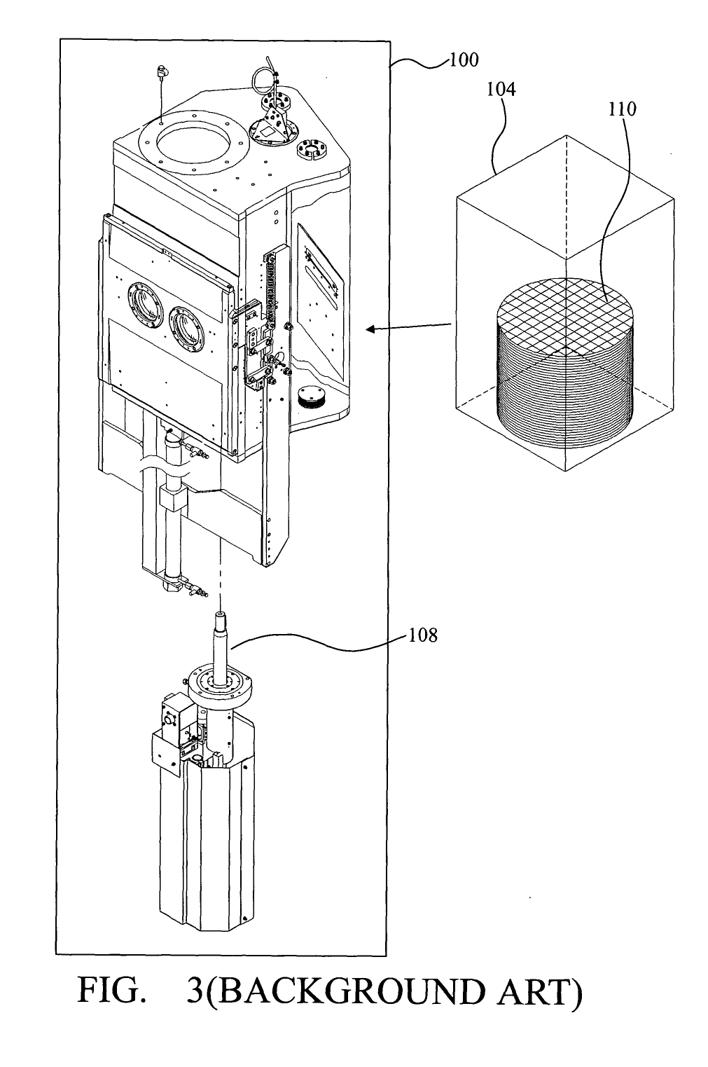

FIG. 4 shows the relationship between the time and the signal levels in a conventional loadlock based on a RGA spectrum;

FIG. 5 is a schematic view of a loadlock according to the first embodiment of the present invention;

FIG. 6 shows the relationship between the time and the signal levels in a loadlock with bellows based on a RGA spectrum in accordance with the first embodiment of the present invention;

FIG. 7 is a schematic view of a loadlock according to the second embodiment of the present invention; and

FIG. 8 shows the relationship between the time and the contamination levels on dummy wafers before and after dummy wafers are delivered to the loadlock; and

FIG. 9 is a schematic view of a loadlock according to the third embodiment of the present invention.

### DETAILED DESCRIPTION OF THE INVENTION

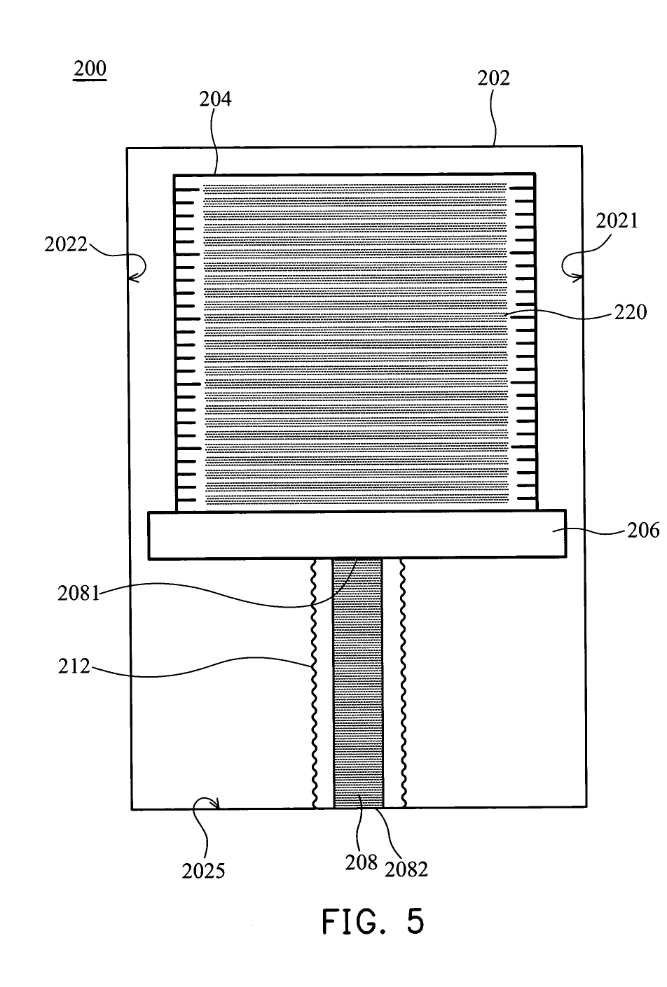

FIG. 5 illustrates a loadlock 200 according to the first embodiment of the present invention. The loadlock 200 is used mainly for loading and unloading a cassette of wafers. The loadlock 200 for delivering wafers 220 in a cassette 204 comprises a chamber 202, a pedestal 206, a retractable shaft 208, and a bellows 212 as vapor trapping means. The chamber 202 has a plurality of walls 2021 and 2022, and a bottom surface 2025. The pedestal 206 supports the cassette 204 and is disposed in the chamber 202. The cassette 204 is also separable from the chamber 202. The retractable shaft 208 has a top end 2081 and a bottom end 2082. The top end 2081 is connected to the pedestal 206 and the bottom end 2082 is connected to the bottom surface 2025, a reference point allowing adjustment of the position of the pedestal 206 so that the retractable shaft 208 can change the elevation of the pedestal 206 to deliver wafers 220 to the next reaction chamber. The bellows 212 has two ends. One end 2121 is disposed on the pedestal 206, and the other end 2122 is sealed at the bottom end 2082 of the retractable shaft 208. The retractable shaft 208 is fully enclosed by the bellows 212. As mentioned above, the major contamination source is the lubricant applied on the shaft 208. Thus, the present invention uses the bellows 212 to fully enclose the shaft 208 from top to bottom so that the lubricant on the shaft is completely trapped by the bellows 212 and thus does not evaporate into the loadlock chamber.

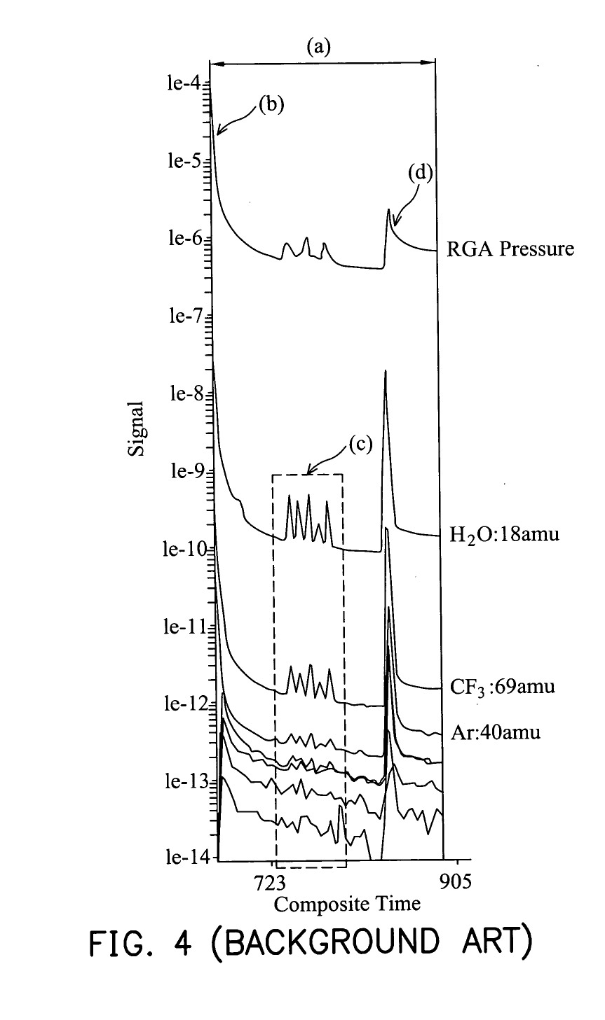

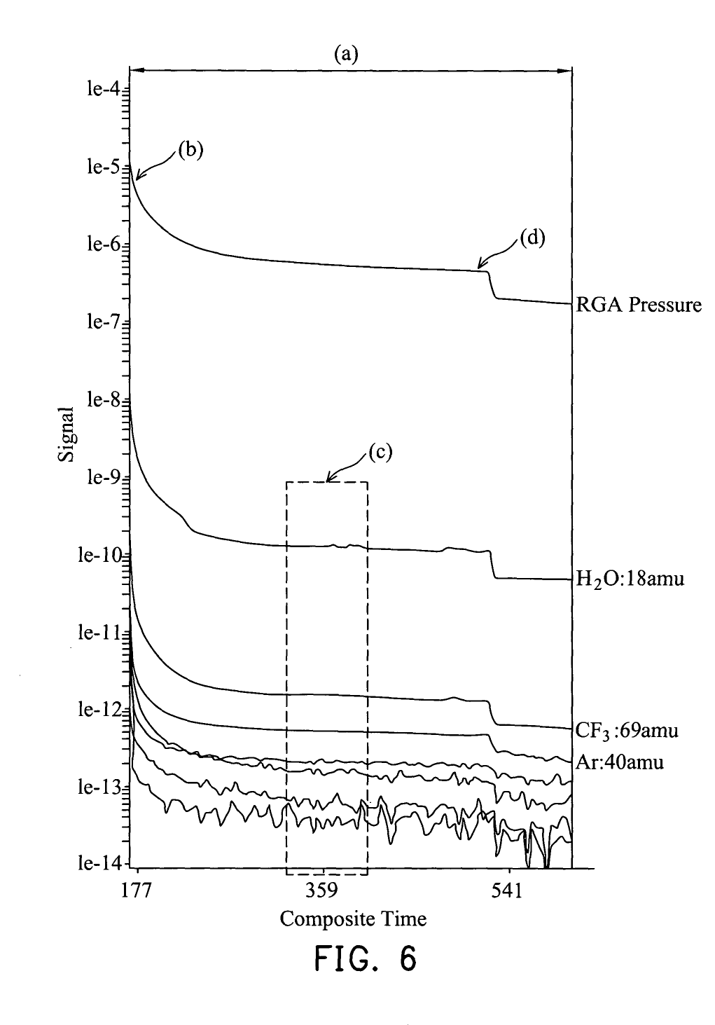

RGA spectrum in FIG. 6 shows the effectiveness of the bellows in the present invention. RGA spectrum is performed in the loadlock according to the first embodiment when the shaft 208 moves. FIG. 6 shows the relationship between the time and the signal levels in the loadlock with a bellows 212. The signal level of outgas H₂O with 18 amu initially increases to a high level between lxe⁻⁸ and lxe⁻⁷ when a silt valve (not shown) of the loadlock is open as indicated at time (b). Then the signal level immediately decreases to between lxe⁻¹⁰ and lxe⁻⁹. Unlike the RGA spectrum result of the conventional loadlock in FIG. 4, because shaft 208 of the first embodiment is enclosed by a bellows 212, the signal level remains consistent between lxe⁻¹⁰ and lxe⁻⁹ throughout the span of the process. Likewise, the outgas CF₃⁺ with 69 amu is shown in a rough curve similar to that of H₂O. When the shaft 208 is moving during the time period (c), the level remains consistent between lxe⁻¹² and lxe⁻¹¹ until the silt valve is closed at time (d). Another outgas, such as Ar with 40 amu, has a similar RGA result. This clearly demonstrates that the bellows 212 surrounding the shaft 208 prevents the lubricant from entering the loadlock chamber 200, and thereby prevents the lubricant from penetrating the wafer surfaces.

In a preferred embodiment of the present invention, the bellows 212 for trapping the vapor of the lubricant is hollow, cylindrical, and compressible by external force, requiring a stroke of over 9 inches. When the pedestal 206 descends to its lowest level, the bellows 212 must be compressed to a height less than 2.25 inches. Thus, the surface of the bellows is corrugated to accommodate the required compression and to return to its original shape. Furthermore, the bellows 212 is of highly impermeable and flexible materials such as rubber, stainless steel or other materials with high ductility, further being sealed on the shaft to keep the lubricant.

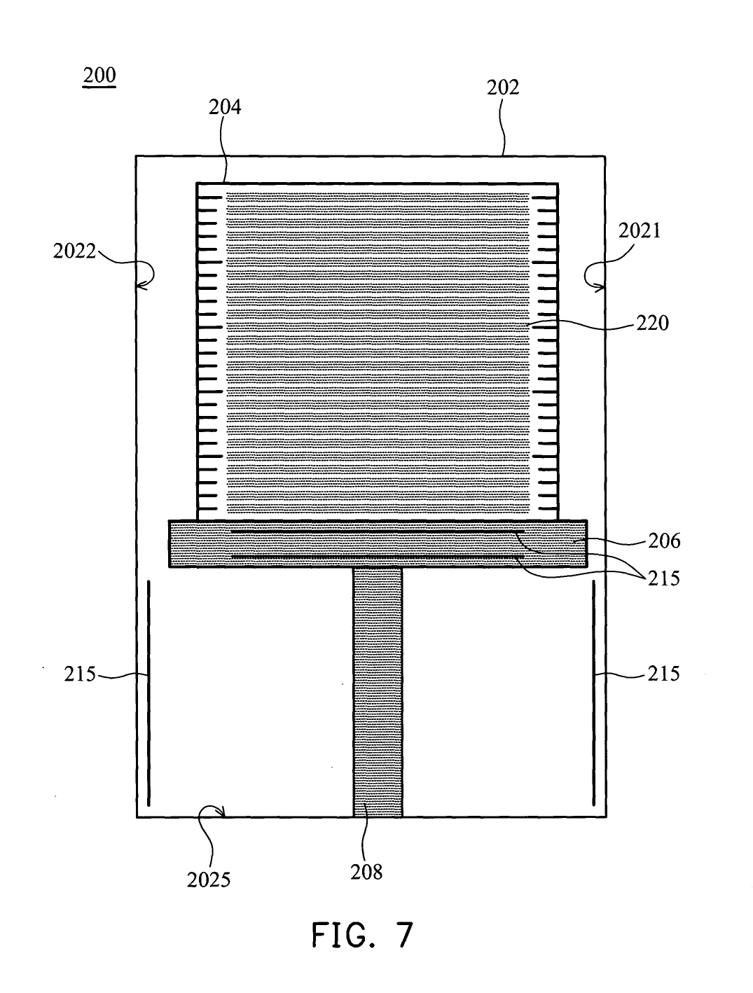

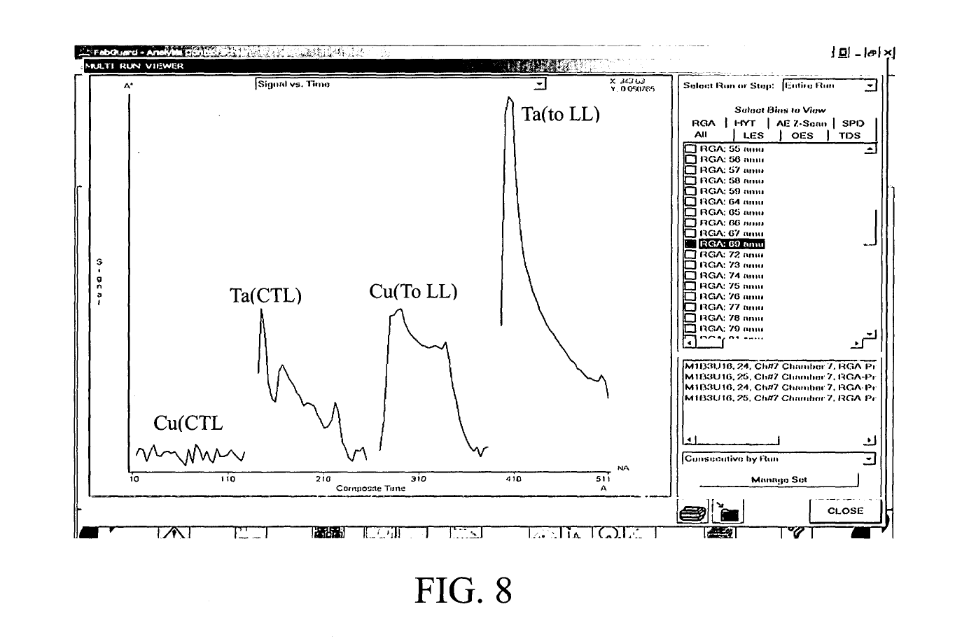

In the second embodiment, the loadlock 200 comprises a chamber 202, a pedestal 206, and a retractable shaft 208, and further includes a plurality of metal attractors 215 as vapor trapping means disposed on the inner walls 2021 and 2022 of the chamber 202, as shown in FIG. 7. Moreover, the lubricant has affinity for metal, alloy steel, copper (Cu), stainless steel, and other metals such as aluminum (Al), titanium (Ti), nickel (Ni), iron (Fe) and cobalt (Co) and alloys thereof. Thus, CF₃⁺ ions of the lubricant vapor are directly absorbed into the surface of the metal attractors 215 instead of the processed wafers 220. The metal attractors 215 can be disposed on any part of the inner walls 2021 and 2022 of the chamber 202 and on the pedestal 206. When at least one metal attractor 215 is disposed within the loadlock, the contamination level is reduced significantly. Among the aforementioned metals, tantalum (Ta) is a particularly good attractor. FIG. 8 shows the contamination levels with a Cu attractor and with a Ta attractor. In this experiment, a dummy wafer acts as a metal attractor. As shown in FIG. 8, the contamination levels of a dummy wafer deposited with copper and another dummy wafer deposited with tantalum thereon are compared. “Ta(CTL)” and “Cu(CTL)” represent the contamination level on a wafer with tantalum and on a wafer with copper respectively before the wafers enter the loadlock. RGA spectrum shows that Ta(CTL) originally has much higher impurities of CF₃⁺ at mass of 69 amu than Cu(CTL) does. “Ta(to LL)” and “Cu(to LL)” indicate contamination levels of the Ta wafer and the Cu wafer in the loadlock respectively, after both are delivered to the loadlock (LL). FIG. 8 shows that the intensity of the Ta(to LL) signal is much higher than that of the Cu(to LL) signal. If the Ta wafer is replaced with a Ta attractor and disposed in the loadlock, the same results can be achieved. Therefore, the impurities within the loadlock are nearly removed by the Ta attractor.

As described in the above embodiments, a loadlock includes vapor trapping means such as a bellows preventing lubricant vapor diffusion into the chamber or at least a metal attractor removing the contaminants from the wafers.

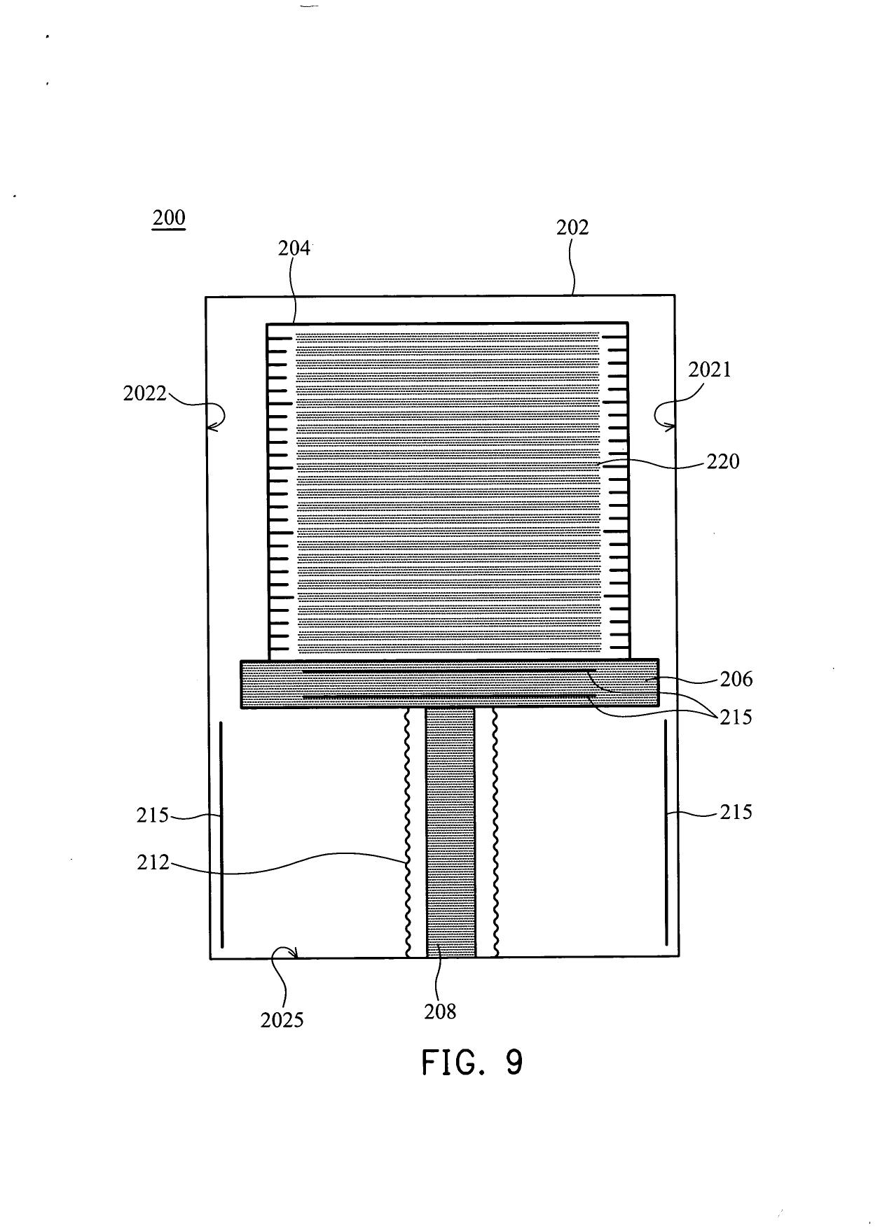

In the third embodiment of the present invention, as shown in FIG. 9, the loadlock comprises a chamber 202, a pedestal 206, a retractable shaft 208, a flexible sleeve 212, and a plurality of metal attractors 215. The pedestal 206 is again disposed in the chamber 202. The retractable shaft 208 supports the pedestal 206. The flexible sleeve 212 encloses the retractable shaft 208. The flexible sleeve 212 has a bellows structure, similar to the bellows in the first embodiment and is compressible by external force. By installing the above two main elements, a flexible sleeve (bellows) and a plurality of metal attractors, the lubricant vapor in the loadlock is completely trapped and thus swirl defects are minimized to negligible levels. Accordingly, the contamination levels on the first six wafers in the inventive loadlock are at acceptable levels, and thus the yield rate is effectively improved.

The metal attractor 215 according to a preferred embodiment of the present invention is a rectangular sheet or a plate. It is, however, understood that the attractor may be provided in various configurations, and thus for example, may alternatively have a circular profile similar to that of a wafer.

The advantage of the present invention is that swirl defects on the wafers are significantly reduced and yield rate is greatly improved. It should be noted that merely disposing the bellows 212 on an existing shaft of a conventional loadlock may not achieve the intended result. Due to the high stroke of the bellows, the inner surface of the bellows touches the shaft due to pressure differential. A minimum of three collar guides are needed in a conventional loadlock to prevent the contact. This requires the bellows to be compressed to at least 4 to 5 inches, higher than the minimum required compression of about 3 inches. Allowing maximum bellows compression, the entire loadlock must be redesigned. Thus, to optimize bellow compression, the whole loadlock must be redesigned in order to accommodate the bellows. In addition, custom tooling may be required for long-term reliability.

When the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A loadlock for wafers, comprising:
a chamber having a bottom surface;
a pedestal disposed in the chamber;
a retractable shaft, having a top end and a bottom end, the top end being connected to the pedestal and the bottom end being connected to the bottom surface; and
a bellows, having a first end disposed on the pedestal and a second end sealed at the bottom end of the retractable shaft, the retractable shaft being fully enclosed by the bellows.

2. The loadlock as claimed in claim 1, wherein the bellows is hollow and cylindrical and is compressible by external force.

3. The loadlock as claimed in claim 1, wherein the chamber further has at least a wall and at least a metal attractor disposed thereon.

4. The loadlock as claimed in claim 3, wherein the metal attractor is at least one of copper, aluminum, titanium, nickel, cobalt, tantalum, iron, and alloys thereof.

5. The loadlock as claimed in claim 3, wherein the metal attractor is at least one of a plate and a sheet.

6. The loadlock as claimed in claim 1, further comprising a plurality of metal attractors, disposed on the pedestal.

7. The loadlock as claimed in claim 6, wherein the metal attractor is at least one of copper, aluminum, titanium, nickel, cobalt, tantalum, iron, and alloys thereof.

8. The loadlock as claimed in claim 6, wherein the metal attractor is at least one of a plate and a sheet.

9. A loadlock comprising:
a chamber;
a pedestal disposed in the chamber;
a retractable shaft supporting the pedestal; and
a flexible sleeve enclosing the retractable shaft.

10. The loadlock as claimed in claim 9, wherein the flexible sleeve has a bellows structure and is compressible by external force.

11. A loadlock comprising:
a chamber having at least a wall;
a pedestal disposed in the chamber; and
a first attractor disposed on the pedestal and a second attractor disposed on the wall, respectively.

12. The loadlock as claimed in claim 11, wherein each of the first and the second attractors is at least one of a plate and a sheet.

13. The loadlock as claimed in claim 11, wherein each of the first and the second attractors comprises metal.

14. The loadlock as claimed in claim 13, wherein each of first and the second the attractors is at least one of copper, aluminum, titanium, nickel, cobalt, tantalum, iron, and alloys thereof.

15. The loadlock as claimed in claim 11, further comprising a cassette, containing a plurality of wafers, disposed in the chamber, the cassette being supportable by the pedestal.

16. A loadlock for wafers, comprising:
a chamber having a bottom surface;
a pedestal disposed in the chamber;
a retractable shaft, having a top end and a bottom end, the top end being connected to the pedestal and the bottom end being connected to the bottom surface, a lubricant being applied on the retractable shaft; and
a vapor trapping means for preventing a vapor of the lubricant from contaminating wafers.

17. The loadlock as claimed in claim 16, wherein the vapor trapping means includes a bellows operably enclosing the retractable shaft and trapping the vapor of the lubricant.

18. The loadlock as claimed in claim 17, wherein the bellows has a first end disposed on the pedestal and a second end sealed at the bottom end of the retractable shaft.

19. The loadlock as claimed in claim 16, wherein the vapor trapping means includes at least a metal attractor for trapping the vapor of the lubricant.

20. The loadlock as claimed in claim 19, wherein the chamber has at least a wall, and the metal attractor is disposed on the wall.

21. The loadlock as claimed in claim 19, wherein the metal attractor includes metal.

22. The loadlock as claimed in claim 21, wherein the metal is at least one of copper, aluminum, titanium, nickel, cobalt, tantalum, iron, and alloys thereof.
